(19) United States
(12) Patent Application Publication
(10) Pub. No.: US 2010/0306287 A1
(43) Pub. Date: Dec. 2, 2010

(54) Method and apparatus for global addressing of parcels of land

(76) Inventor: Nabil Raafat Mahrous Raphaeil, Alexandria (EG)

Correspondence Address: Richard J. Hepner, 25291 Fairgreen, Mission Viejo, CA, 92692, US

(21) Appl. No.: 12/454,913

(22) Filed: May 26, 2009

(51) Int. Cl. G06F 17/30

(52) U.S. Cl. 707/955; 707/957; 707/919

(57) ABSTRACT

A method and apparatus for defining a globally-standardized system of addressing for parcels of land is disclosed. The system utilizes physical characteristics of land parcels to identify the unique address and location of said land parcels (herein also referred to as the NSE coordinates) in a global coordinate system. In a preferred embodiment, the geographical center of the land parcel is determined and used as the defining physical characteristic of the land parcel. That geographical center is mapped against the latitude and longitude system currently used as a standard to define positions on the Earth. This method provides an alternative to the various addressing conventions established by national, regional or local governmental entities. The method is adapted to execution on either a general purpose or special purpose computer system to transform physical characteristics of land parcels into useful address and location information and tangible display representations.

### CROSS REFERENCE TO RELATED APPLICATIONS

Not applicable

### STATEMENT REGARDING FEDERALLY SPONSORED RESEARCH OR DEVELOPMENT

Not applicable

### INCORPORATION-BY-REFERENCE OF MATERIAL SUBMITTED ON A COMPACT DISC

Not applicable

### BACKGROUND OF THE INVENTION

1. Field of Invention

The present invention relates generally to the field of defining land parcel locations and addresses. More particularly, the present invention is a novel computer-based method of defining a globally-standardized system of land parcel locations and addresses based upon the physical attributes of each land parcel, and apparatus for practicing the method.

2. Discussion of Related Art

The usefulness of methods to perform addressing of parcels of land is well recognized. Addressing is employed by a wide variety of entities for a wide variety of purposes. These purposes include but are not limited to property ownership records, provision of utility services, mapping, navigation, and delivery of mail and parcels.

Currently, addressing and locations of parcels of land are defined by conventions established by national and/or local governmental entities. For example, in the United States, the address is defined by the names of the city and State in which the parcel is located, in combination with the name of the street and a street number which is generally assigned according to the numbering convention of the city or county. Addressing conventions differ within each geo-political boundary.

Several disadvantages attend the current proliferation of addressing and location conventions. The primary disadvantage is the lack of standardization. Other disadvantages flow from this lack of standardization including complexity, inaccuracy, indefinite information, and the costs attendant to these other disadvantages.

The user of existing geo-political addressing must use employ the conventions of the various geo-political entities. There is no consistency in numbering and naming of addresses and locations. The user must deal with a complex combination of street names, street numbering systems, and national and local political boundaries and sub-boundaries. This conversion between multiple addressing and location conventions is time consuming and prone to error; both of which translate into unnecessary cost. Further, the information contained in a geo-political address is indefinite; it provides no true information regarding the location of the land parcel. The location of the land parcel may only be approximately determined by employing some form of map which permits decrypting of the address information into meaningful location information.

Geocoding has developed as an approach to providing a limited degree of standardization. In geocoding, an address is matched to corresponding latitude and longitude coordinates. While the latitude and longitude coordinates seem to provide some degree of useful location information, that degree of usefulness is dependent upon the accuracy of the geo-political conventions and the accuracy of the translation of those conventions to latitude and longitude coordinates.

Miller, et al., U.S. Pat. No. 7,039,640 discloses a method and system for providing geocodes in response to either complete or partial address information. The Miller disclosure demonstrates the complexity inherent in known geocoding methods. A geocoding engine is required to handle the various address formats used in different countries and jurisdictions. Significant processing and database resources are required to overcome errors due to spelling and to translate the variety of languages and formats used to define addresses. The functionality and accuracy of the system and method is only as robust as the database and processing algorithms.

### BRIEF SUMMARY AND OBJECTS OF THE INVENTION

In view of the foregoing disadvantages inherent in the known methods in the related art, the present invention provides a novel, computer-based method of defining addresses and locations for land parcels without the disadvantages of the related art methods. Specifically, the present invention is a universal method that employs specific geometric characteristics of the land parcels as the basis for defining addresses and locations, then locates those geometric characteristics in a global reference system. In one preferred embodiment of the present invention, the geometric characteristic is the geographical center of the land parcel, and the global reference system is the latitude and longitude system.

The present invention provides a globally-standardized system of addressing and location by employing a consistently defined geometric feature (such as the geographical center) in place of a multitude of geo-political conventions, then mapping that geometric feature against a global standard for identifying location of any point on the Earth (such as the latitude and longitude convention).

The present invention eliminates the inaccuracies inherent in related art methods by employing a invariable, non-arbitrary, mathematically calculated geometric basis for identifying addresses and locations.

The present method is readily adapted to computer implementation. It is significantly simpler to deal with the numerical data involved in calculating address and location information from geometric data than to deal with street, city, regional and national names, especially when those names may be expressed in multiple languages an contain errors in spelling, syntax or convention.

The present invention is a system which integrates a computer-based method and an apparatus with which to execute the method. The method transforms physical characteristics of land parcels into useful address and location information and tangible display representations. The method is adapted to execution on a general purpose computer to transform said general purpose computer into a special purpose computer that transforms the input physical data into useful information and display representations. The method is also adapted to execution on a special purpose computer that is specifically configured to the execution of the method.

The method is adapted to execution on either a general purpose or special purpose computer system to transform physical characteristics of land parcels into useful address and location information and tangible display representations.

The present invention simplifies re-addressing when a land parcel is subdivided. A straightforward calculation based upon the geometries of the subdivided land parcels results automatically in new address and location identifiers.

The present invention eliminates the costs associated with translation between various addressing and location conventions, and the inaccuracies and inefficiencies associated with vague and error prone geo-political conventions. These costs include the complexity of database and processing requirements as well as time and monetary resources.

The disclosed method may be used as a stand-alone system or in conjunction with national, regional and/or local system conventions.

Other advantages of the present invention will become readily apparent to those with skill in the art from the following figures, descriptions and claims. As will be appreciated by those of skill in the art, the present invention may be embodied in a plurality of apparatuses, systems or methods. The advantages of such embodiments are intended to be within the scope of the present invention and, therefore, the examples set forth herein shall not be limiting.

### BRIEF DESCRIPTION OF THE DRAWINGS

The nature of this invention, as well as all its objects and advantages, will become readily apparent and understood upon reference to the following detailed description when considered in conjunction with the accompanying drawings, in which like reference numerals designate like parts throughout the figures thereof, and wherein:

FIG. 1 presents the geometry necessary to describe the present global addressing method.

FIG. 2 presents the geometry necessary to describe the method of calculating the geographical center of a land parcel.

FIG. 3 presents the geometry necessary to discuss a general method for determining the geographical center of a land parcel of irregular shape.

FIG. 4 provides a flowchart showing the steps in a preferred embodiment of the method.

FIG. 5 presents a schematic representation of an apparatus for implementing the computer-based method.

### DETAILED DESCRIPTION OF THE PREFERRED EMBODIMENTS

The following description is provided to enable any person skilled in the art to make and use the invention and sets forth the best modes contemplated by the inventor of carrying out the invention. The present invention shall not be limited to the examples disclosed. Rather, the scope of the invention shall be as broad as the claims will allow.

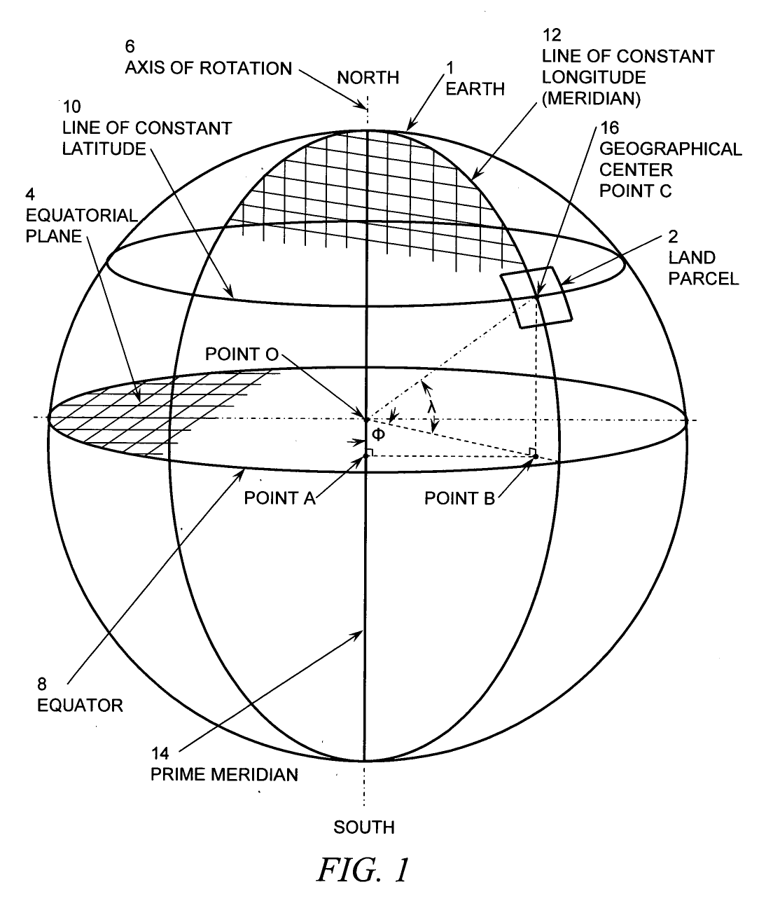

Referring now to the drawings, FIG. 1 presents the geometry necessary to describe the present global addressing method. FIG. 1 represents the Earth 1 as a transparent sphere. The equatorial plane 4 bisects the Earth 1 passing through the center of the Earth Point O and perpendicular to the Earth's axis of rotation 6. The intersection of the equatorial plane 4 and the surface of the Earth 1 defines the equator 8. The intersections of planes that are parallel to the equatorial plane 4 and the surface of the Earth 1 define lines of constant latitude. The latitude λ of any point on a line of constant latitude is defined as the elevation angle of the line of constant latitude above the equator 8. In the figure, the latitude λ of the line of constant latitude 10 is angle BOC. The latitude at any point on the equator 8 is zero degrees. Similarly, the intersection of a plane that passes through the length of the Earth's axis of rotation 6 and the surface of the Earth 1 defines a line of constant longitude called a meridian. By conventional definition, the meridian which passes through the Royal Astronomical Observatory in Greenwich, London, United Kingdom is called the Prime Meridian 14. The longitude φ of any point on a meridian is defined as the angle between the plane of the Prime Meridian 14 and the plane of the meridian. In the figure, the longitude φ of the meridian 12 is angle BOA. The longitude φ at any point on the Prime Meridian 14 is zero degrees.

The location of any point on Earth 1 may be uniquely described by the combination of that location's latitude λ and longitude φ. In a preferred embodiment of the present invention, the universal conventions of latitude λ and longitude φ are employed to define the location and address of each and every parcel of land; referred to in this disclosure as the land parcel's NSE. The latitude λ and longitude φ of a point calculated from the geometry of a land parcel 2 is used as the globally-standardized address, or NSE, of that land parcel 2. While any geometric relationship may be used to define the point to be used as the globally-standardized address of a parcel of land, a preferred embodiment of the present invention employs the geographical center of the land parcel as the standard. The globally-standardized address of land parcel 2 is therefore defined by the unique coordinates (λ, φ) of the parcel's geographical center 16.

In one alternative embodiment of the present invention, an additional address/location parameter to identify the altitude of the land parcel. That additional parameter may be, for example, the weighted average height above sea level of the entire land parcel or the height above sea level of the geometric center of the land parcel.

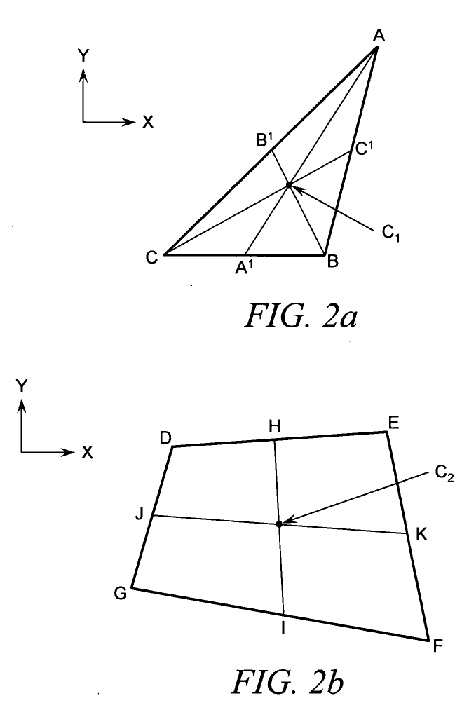

FIG. 2 presents the geometry necessary to describe the method of calculating the geographical center of a land parcel. In geography, the centroid of a region of the Earth's surface, projected radially onto said surface, is known as its geographical center. This radially projected region is treated as a two-dimensional plane of uniform density for the purpose of calculating the centroid, or geographical center, of the region. In geometry, the centroid of a plane figure X is the intersection of all lines that divide X into two parts of equal moment about the line. The centroid may be calculated by a number of mathematical means, including geometric decomposition and application of integral formulae. An exemplary discussion of geometric decomposition is presented herein.

The geometry necessary to describe the method of calculating the centroid of a triangle is presented in FIG. 2a. The centroid of a triangle is the: point of intersection of its medians—the lines joining each vertex with the midpoint of the opposite side. The centroid C₁ of triangle ABC is located at the intersection of its medians A-A¹, B-B¹ and C-C¹. Expressed mathematically, the Cartesian coordinates of the centroid C₁ are the means of the coordinates of the three vertices. If the vertices are A=(xₐ,yₐ), B=(x_{b},y_{b}), and C=(x_{c},y_{c}), then the centroid C₁ is

C₁=(1/3)(A+B+C)=[(1/3)(xₐ+x_{b}+x_{c}), (1/3)(yₐ+y_{b}+y_{c})]

The geometry necessary to describe the method of calculating the centroid of a quadrilateral is presented in FIG. 2b. The centroid of a quadrilateral is the point of intersection of its bimedians—the lines joining the midpoints of opposite sides. The centroid C₂ of quadrilateral DEFG is located at the intersection of its bimedians H-I and J-K.

More generally, the centroid of a closed polygon defined by n vertices (xᵢ,yᵢ) can be calculated as follows.

The area of the polygon is

$$A = \frac{1}{2} {\sum }_{i = 0}^{n - 1} ( {x}_{i} {y}_{i + 1} - {x}_{i + 1} {y}_{i} ) ,$$

and its centroid is (C=Cx,Cy) where

$${C}_{x} = \frac{1}{6 A} {\sum }_{i = 0}^{n - 1} ( {x}_{i} + {x}_{i + 1} ) ( {x}_{i} {y}_{i + 1} - {x}_{i + 1} {y}_{i} )$$

$${C}_{y} = \frac{1}{6 A} {\sum }_{i = 0}^{n - 1} ( {y}_{i} + {y}_{i + 1} ) ( {x}_{i} {y}_{i + 1} - {x}_{i + 1} {y}_{i} ) .$$

In these formulas, the vertex (xₙ,yₙ) is assumed to be the same as (x₀,y₀).

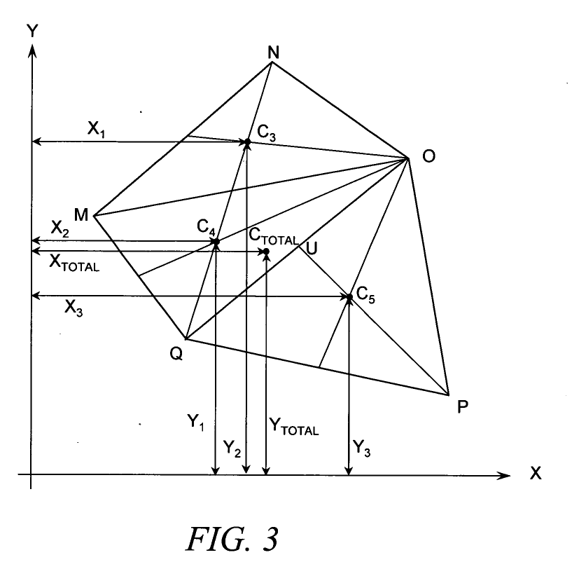

FIG. 3 presents the geometry necessary to discuss the geometric decomposition method for determining the geographical center of a land parcel of irregular shape. The centroid of a polygon can be computed by dividing it into a finite number of simpler polygons, calculating the area and centroid of each of the component polygons, and summing the first moments of areas. For example, polygon MNOPQ may be divided into triangles MNO, MOQ and OPQ. The area of the irregular polygon MNOPQ, A_{MNOPQ}, is the sum of the areas of the component triangles=A_{MNO}+A_{MOQ}+A_{OPQ}. The centroid of each component triangle (C₃, C₄ and C₅) is calculated in accordance with the methodology presented in the discussion of FIG. 2a. The location of the centroid of the irregular polygon MNOPQ (C_{TOTAL}) is located at the point (X_{TOTAL}, Y_{TOTAL}) where X_{TOTAL}=(A₁X₁+A₂X₂+A₃X₃)/A_{TOTAL}, and Y_{TOTAL}=(A₁Y₁+A₂Y₂+A₃Y₃)/A_{TOTAL}.

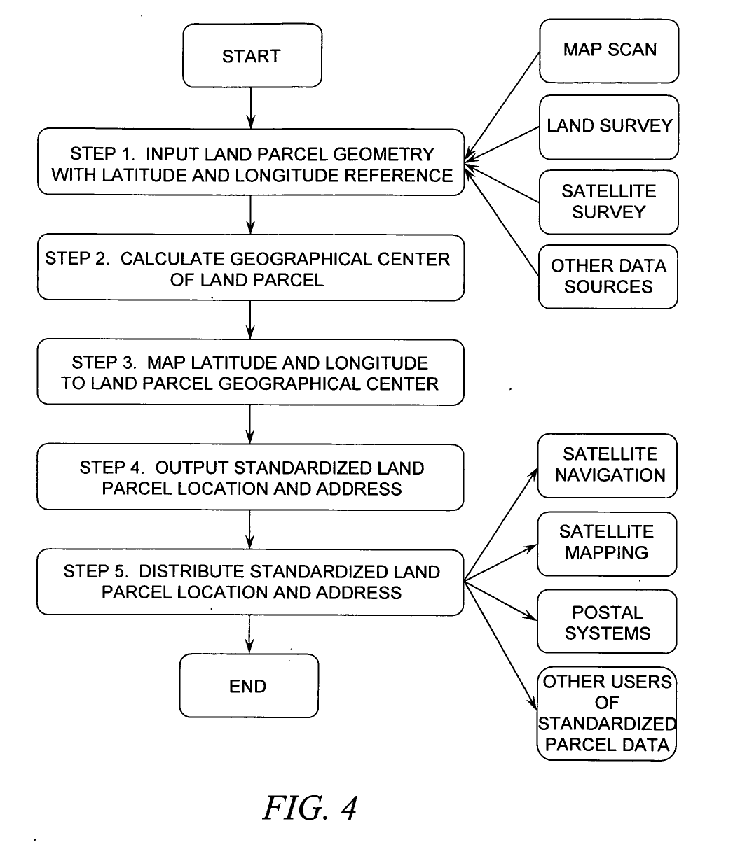

FIG. 4 provides a flowchart showing the steps in a preferred embodiment of the method. In STEP 1, land parcel geometry is input, including a latitude and longitude reference point. The input may be from any available source. The input source may be a scanned geographic map, land survey data, satellite survey data, national/state/regional/local records, or other available source of land parcel geometrical data. In STEP 2, the geometric relationships and algorithms discussed in connection with FIG. 2 are employed to calculate the centroid, or geometrical center of the land parcel. In STEP 3, globally-standardized latitude and longitude coordinates are associated with the geometrical center of the land parcel. STEP 4 is the process output of globally-standardized land parcel locations and addresses. In an additional STEP 5, the globally-standardized land parcel location and address information is distributed to users of that information. Typical users of globally-standardized land parcel location and address data include, but are not limited to the satellite navigation and mapping industries, and postal and delivery systems.

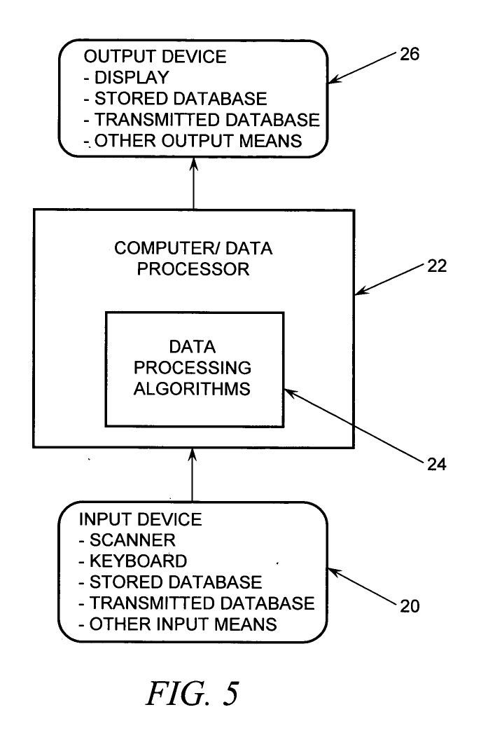

FIG. 5 presents a schematic representation of an apparatus for implementing the computer-based method. The method is adapted to execution on a general purpose computer to transform said general purpose computer into a special purpose computer that transforms the input physical data into useful data and display representations and information. The method is also adapted to execution on a special purpose computer that is specifically configured to the execution of the method. Input of land parcel geometrical data is accomplished employing an input device 20. The input device 20 may be a scanner, data entry keyboard, a stored or transmitted database, or any other useful means or device. The input device 20 transmits the land parcel geographical data to a computer/data processor 22 which operates on the land parcel geographical data with data processing algorithms 24. The resultant output, globally-standardized location and addressing information, is communicated to the users of that information by an output device 26. The output device 26 may be a display, a stored or transmitted database, or any other useful means or device.

The individual steps of the disclosed method may be modified, interchanged or combined, or additional steps added without departing from the spirit of the invention. Further, the present invention may be exercised in alternative embodiments other than those illustrated in the Figures. In addition, the present invention may be adapted to a variety of application beyond those enumerated in this disclosure. Such modifications, additions, alternatives and adaptations are within the contemplation of the present invention. The exemplary method and embodiments disclosed are not intended to limit the scope of this invention. Accordingly, the scope of the invention should be determined not by the embodiments illustrated, but by their legal equivalents, and shall be as broad as the claims will allow.

What is claimed is:

1. A computer-based method for defining a universal, globally-standardized address and location for parcels of land comprising the following steps:
(a) inputting land parcel geometry data, including an indexing reference point providing the capability to index the land parcel relative to a global location identification system;
(b) selecting a geometric attribute of the land parcel to be used as the standard parameter upon which universal addressing will be based;
(c) calculating the selected geometric attribute of the land parcel;
(d) identifying the global location coordinates, relative to the global location identification system, to define the location and address of the land parcel by employing the indexing reference point to index the calculated geometric attribute of the land parcel to the global location identification system; and
(e) outputting the universal, globally-standardized address and location information of the land parcel to the user of said address and location information and/or storing the address and location information for later retrieval.

2. An apparatus for executing the method of claim 1, comprising:
(a) an input device,
(b) a computer/data processor,
(c) data processing algorithms, and
(d) an output device.

3. The apparatus of claim 2, wherein:
(a) said input device is a scanner, keyboard, stored database, transmitted database, or other input means; and
(b) said output device is a display, stored database, transmitted database, or other output means.

4. The apparatus of claim 2, wherein said apparatus is a general purpose computer which is transformed into a special purpose computer for defining globally-standardized addresses for parcels of land through the execution of the method of claim 1.

5. The apparatus of claim 2, wherein the computer/data processor is a special purpose computer specifically configured to define globally-standardized addresses for parcels of land according to the method of claim 1.

6. A computer-based method for defining a universal, globally-standardized address and location for a land parcel comprising the following steps:
(a) inputting land parcel geometry data, including an indexing reference point providing the capability to index the land parcel relative to the global latitude and longitude location identification system;
(b) selecting the geometric center as the geometric attribute of the land parcel to be used as the standard parameter upon which universal addressing will be based;
(c) calculating the geometric center of the land parcel;
(d) identifying the latitude and longitude coordinates of the geometric center, relative to the global latitude and longitude location identification system, to define the location and address of the land parcel by employing the indexing reference point to index the calculated geometric center of the land parcel to the global latitude and longitude location identification system; and
(e) outputting the universal, globally-standardized address and location information of the land parcel to the user of said address and location information and/or storing the address and location information for later retrieval.

7. An apparatus for executing the method according to claim 6, comprising:
(i) an input device,
(ii) a computer/data processor,
(iii) data processing algorithms, and
(iv) an output device.

8. The apparatus of claim 7, wherein:
(a) said input device is a scanner, keyboard, stored database, transmitted database, or other input means; and
(b) said output device is a display, stored database, transmitted database, or other output means.

9. The apparatus of claim 7, wherein said apparatus is a general purpose computer which is transformed into a special purpose computer for defining globally-standardized addresses for parcels of land through the execution of the method of claim 6.

10. The apparatus of claim 7, wherein the computer/data processor is a special purpose computer specifically configured to define globally-standardized addresses for parcels of land according to the method of claim 6.
